(19) United States
(12) Patent Application Publication
(10) Pub. No.: US 2015/0138580 A1
(43) Pub. Date: May 21, 2015

(54) CENTRALIZED CONTROLLER SERVING MULTIPLE DOCUMENT PROCESSING DEVICES

(71) Applicant: XEROX CORPORATION, Norwalk, CT (US)

(72) Inventors: Francis Kapo Tse, Rochester, NY (US); Rui J. Ferreira, Pittsford, NY (US)

(73) Assignee: XEROX CORPORATION, Norwalk, CT (US)

(21) Appl. No.: 14/084,866

(22) Filed: Nov. 20, 2013

(51) Int. Cl. H04N 1/00

(52) U.S. Cl. CPC H04N 1/00413; H04N 1/00474; H04N 1/00204; H04N 2201/0094
USPC 358/1.13

(57) ABSTRACT

Methods and systems establish dynamic profiles for each of many document processing devices, based on current device connection specifications, current device drivers, current device capabilities, and current device workflow functions using a centralized connection device. These methods and systems provide device menu options from the centralized connection device to graphic user interfaces of the document processing devices. The device menu options provided from the centralized connection device displays the graphic user interfaces for the control of the document processing devices with the currently available workflows (that will be processed using a corresponding device and at least one other device of the document processing devices) and currently available management functions for the corresponding device and the other device(s) of the document processing devices. The “corresponding” device corresponds to the specific one of the graphic user interfaces receiving input to the device menu options.

### BACKGROUND

Systems and methods herein generally relate to document processing devices and to systems and methods that coordinate actions of different document processing devices to perform workflows and management functions using a centralized controller.

Document processing devices are becoming increasingly sophisticated in their capability to perform multiple functions and in their ability to communicate with other document processing devices. However, as the sophistication of document processing devices increases, so do their associated costs, complexity, power usage, etc.

For example, some modern document processing devices include sophisticated graphic user interfaces that allow the user to select from a myriad of performance options. In addition, some document processing devices can provide menu screens that control other document processing devices. For example, a sophisticated standalone scanner can provide print menu options that are available from a network-connected printer. In some systems, the printing menu presented on the standalone scanner emulates the menu that the user would see if they were directly operating the network connected printer.

However, such menu emulation devices require each individual component to have substantial computing and display resources so that they can communicate with other document processing devices and perform the internal computing required to emulate the menu of a different device. Again, such additional internal resources increase the associated costs, complexity, power usage, etc., as well as decrease the yield and reliability of such highly sophisticated document processing devices. Therefore, conventional document processing devices that have sophisticated communication and menu emulation abilities each must individually carry the computational and equipment cost associated with such sophisticated user interfaces.

### SUMMARY

An exemplary centralized connection entity herein comprises external ports operatively connected to an internal processor and to external document processing devices. The document processing devices each have their own graphic user interface. The exemplary centralized connection entity also includes modules of instructions.

Such modules include a mapping module that maps the external ports to corresponding document processing devices, a device driver selector module acquiring and storing drivers corresponding to each of the document processing devices, and a device presentation selector module that provides device selection services to the graphic user interfaces of the document processing devices.

The processor establishes dynamic profiles for each of the document processing devices. Each of such dynamic profiles comprises (for each of the document processing devices) current device connection specifications based on the mapping, and current device drivers based on the stored drivers. The device selection services displayed on the graphic user interfaces of each of the document processing devices by the device presentation selector module comprise currently available workflows processed using a corresponding device (a device being operated by a user selecting one of the device service selections from a graphic user interface) and other devices of the document processing devices, as well as currently available management functions of the corresponding device and the other devices of the document processing devices.

The currently available workflows and the currently available management functions are based on the dynamic profiles of each of the document processing devices, and the currently available workflows and the currently available management functions change as the dynamic profiles of each of the document processing devices change. The currently available workflows can include, for example, scan services, fax services, copy services, print services, document processing services, and document finishing services, or an execution of a combination of these functions in a single click. The currently available management functions can include, for example, accounting services, management services, presentation services, and authentication services.

Thus, a single selection of just one of the device service selections presented on the graphic user interface of a corresponding device can select a currently available workflow that utilizes functionality of one or many of the other document processing devices. Each individual device may lack sufficient computerized resources to be capable of independently establishing such dynamic profiles and providing the device selection services that this centralized connection device can.

Other centralized connection devices herein similarly include one or more processors, external ports operatively connected to the processor and to document processing devices, and one or more non-transitory computer-readable memory devices operatively connected to the processor. The document processing devices each have some form of graphic user interface.

The processor maps the external ports to the document processing devices to establish and store (in the non-transitory computer-readable memory) current device connection specifications. The processor also acquires drivers corresponding to each of the document processing devices to establish and store (in the non-transitory computer-readable memory) current device drivers. The processor further determines current capabilities of each of the document processing devices to establish and store (in the non-transitory computer-readable memory) current device capabilities. The processor additionally determines current workflow functions of each of the document processing devices to establish and store (in the non-transitory computer-readable memory) current device workflow functions.

The processor then establishes dynamic profiles for each of the document processing devices, based on the current device connection specifications, the current device drivers, the current device capabilities, and the current device workflow functions. The processor of the centralized connection device can then provide device menu options to graphic user interfaces of the document processing devices.

The device menu options provided from the processor of the centralized connection device cause the graphic user interfaces of the document processing devices to display currently available workflows (that will be processed using a corresponding device and at least one other device of the document processing devices) and currently available management functions for the corresponding device and the other device(s) of the document processing devices. The “corresponding” device again corresponds to the specific one of the graphic user interfaces receiving input to the device menu options.

Exemplary methods herein map external ports of the centralized connection device to document processing devices to establish and store (in the non-transitory computer-readable memory of the centralized connection device) current device connection specifications, using a processor of the centralized connection device. Further, such methods acquire drivers corresponding to each of the document processing devices to establish and store (in the non-transitory computer-readable memory of the centralized connection device) current device drivers, using the processor.

Additionally, such methods determine the current capabilities of each of the document processing devices to establish and store (in the non-transitory computer-readable memory of the centralized connection device) current device capabilities, using the processor. These methods determine the current workflow functions of each of the document processing devices to establish and store (in the non-transitory computer-readable memory of the centralized connection device) current device workflow functions, using the processor.

Then, such methods can establish dynamic profiles for each of the document processing devices, based on the current device connection specifications, the current device drivers, the current device capabilities, and the current device workflow functions, using the processor. These methods then provide device menu options to graphic user interfaces of the document processing devices, using the processor.

The device menu options provided from the processor of the centralized connection device cause the graphic user interfaces of the document processing devices to display currently available workflows (that will be processed using a corresponding device and at least one other device of the document processing devices) and currently available management functions for the corresponding device and the other device(s) of the document processing devices. The “corresponding” device again corresponds to the specific one of the graphic user interfaces receiving input to the device menu options.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating devices herein;

FIG. 2 is a schematic diagram illustrating devices herein;

FIG. 3 is a schematic diagram illustrating devices herein;

FIG. 4 is a schematic diagram illustrating devices herein;

FIG. 5 is a schematic diagram illustrating devices herein;

FIG. 6 is a schematic diagram illustrating systems herein;

FIG. 7 is a schematic diagram illustrating devices herein;

FIG. 8 is a schematic diagram illustrating devices herein; and

FIG. 9 is a flow diagram of various methods herein.

### DETAILED DESCRIPTION

As mentioned above, conventional products have to individually carry the cost for the sophisticated user interfaces that have connectivity to multiple devices. The systems and methods herein provide a separate controller that creates a user interface connectivity gateway for multiple devices, thereby avoiding the need for each device to individually carry the computational and resource costs for the multi-device user interface. The methods and systems herein thus provide a shared entity that reduces the system cost for other devices. This is beneficial for many devices, such as lower end devices that do not have the processing power/memory needed to provide sophisticated multi-device user interfaces on their own.

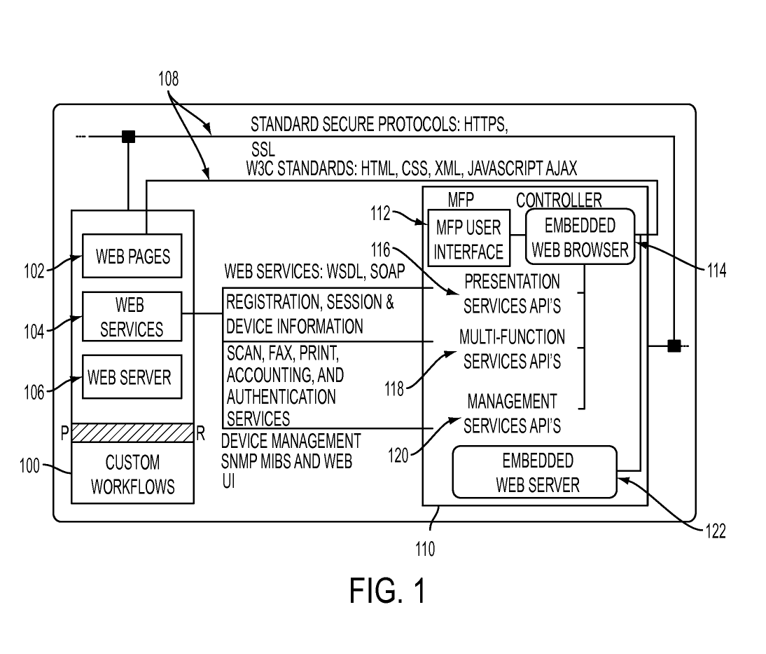

FIG. 1 shows an architecture that includes custom workflows 100 that can be created by manufacturing organization or individual clients of such organizations. Such custom workflows utilize Web pages 102, Web services 104, through the functionality of a Web server 106. Each individual document processing device (such as a multi function printer (MFP)) will include a controller 110 connected to the Web pages 102, Web service 104, and Web server 106 via a wired or wireless, local or wide area, network 108.

For example, the network 108 can operate according to many different protocols including standard secure protocols such as, hypertext transfer protocol secured (HTTPS); secure socket layer (SSL); etc., as well as World Wide Web Consortium (W3C) standards including hypertext markup language (HTML), cascading style sheets (CSS), extensible markup language (XML), JavaScript® (a software program available from Adobe® Corporation, San Jose, Calif., USA), Asynchronous JavaScript and XML (AJAX), etc.

The web services 104 can include, for example, registration, session, and device information and can be operated through, for example, a Web service definition language (WSDL), simple object access protocol (SOAP), etc. Also, the Web services provided can be scanning, faxing, printing, accounting, authentication services, device management (such as simple network management protocol management information bases (SNMP MIB's) and web user interfaces (UI)).

The document processing device controller 110 will include or be connected to the user interface 112 of the document processing device (MFP user interface); and each document processing device controller 110 will include its own embedded web browser 114 and embedded Web server 122. As also shown in FIG. 1, the document processing device controller 110 also includes many different application programming interfaces (API's), including presentation services API's 116, multi-function services API's 118, and management services API's 120.

For example, a custom workflow 100 can be created for a particular business application. The workflow 100 can be launched and controlled via user interaction at the user interface 112 of a particular device, such as a printer, fax machine, or multi-function device. The workflow 100 is presented as a web page 102 that is displayed via the browser 114 that is part of the presentation services of the systems and methods herein. Further, the workflow 100 can invoke various web services for functional control and management of the device via the application programming interfaces (APIs) 116, 118, and 120.

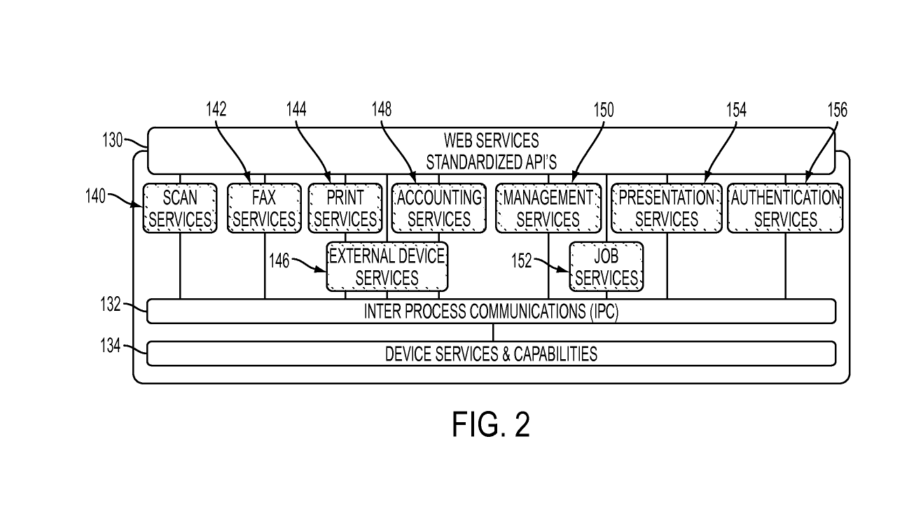

FIG. 2 shows the architecture that supports the capabilities of the systems and methods herein. This architecture includes various web services standardized APIs 130, inter-process communications (IPC) 132 and device services and capabilities 134. The various web services standardized APIs 130 include scan services 140, fax services 142, print services 144, external device services 146, accounting services 148, management services 150, job services 152, presentation services 154, authentication services 156, etc. External web interactions, including presentation interactions, with the device are serviced via such standardized programming interfaces. With systems and methods herein, each device uses a local user interface 112 to utilize the multi-device capabilities provided by the shared entity controller.

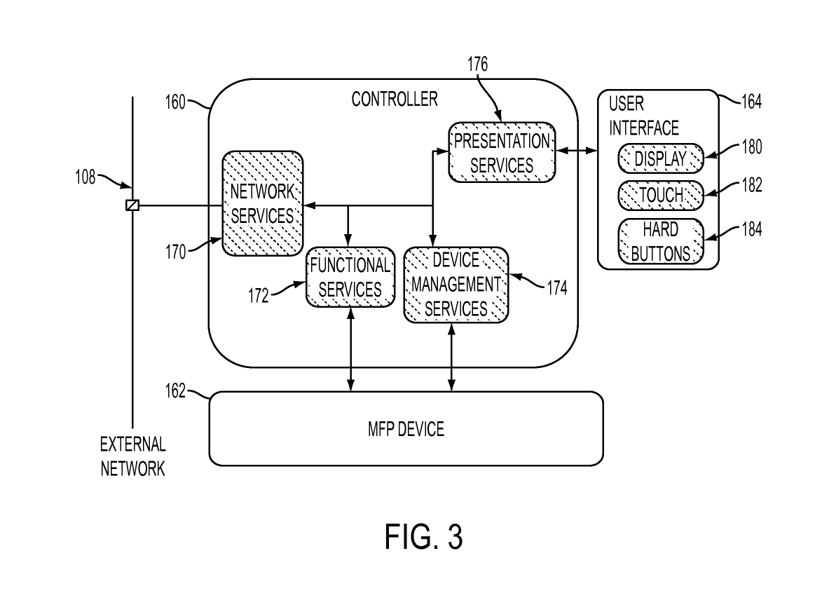

FIG. 3 shows an architecture that includes a controller 160 that is an integral part of a device, such as an MFP device 162. Each device 162 has its own controller 160 and user interface hardware 164. More specifically, the controller 160 that is integral with the device 162 includes network services 170 connected to various networks 108, functional services 172, device management services 174, and presentation services 176. As shown in FIG. 3, the user interface 164 can include a display 180, various touch surfaces 182 (that can be part of the display 180), various hard keys or buttons 184, etc. As mentioned previously, if such devices 162 provide sophisticated communication and menu emulation abilities, each device 162 must individually carry the computational and equipment cost associated with such sophisticated user interfaces.

The systems and methods herein allow users to install workflow applications on devices so that minimum setup and interaction is needed to execute user workflows. In most cases, a user can select an application and click one “go” button to execute a complex workflow that utilizes multiple devices. The local user interface, in many cases, is clicked only once. For example, if a local device uses a scan or copy function, after the user loads the document in a document feeder, a single click of the user interface will cause the document to be scanned and processed through the full workflow.

A local processor that is integral with a document processing device may lack sufficient computing resources to be capable of independently establishing dynamic profiles of multiple network-connected document processing devices, and similarly may be incapable of independently providing menus of workflows that utilize multiple document processing devices. Thus, a local processor may not be able to process various workflows; however, with devices and methods herein network connectivity capabilities allow such local processors to handle a workflow, thereby avoiding requiring the local device to maintain its own high-level computing resources.

From the cost point of view, the same capability provided by methods and systems herein would not be available for lower end document processing products. The limited computing resources of lower end document processing products have conventionally excluded such products from sharing multi-device capabilities and workflows. However, systems and methods herein address the inefficiencies and business limitations, and use a shared entity that allows multiple devices to be connected to a single controller and user interface.

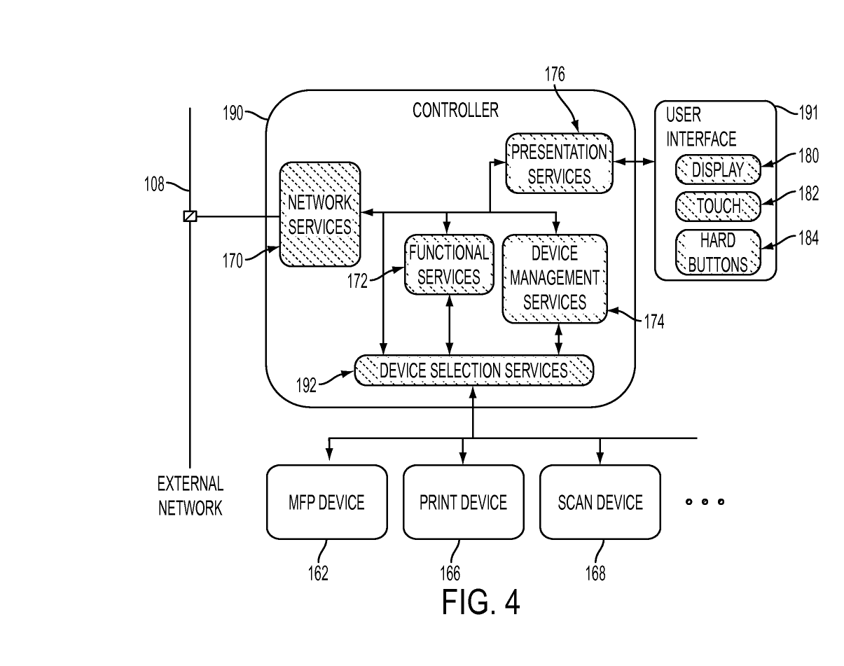

FIG. 4 is a block diagram of the shared concept. The architecture shown in FIG. 4 includes a network-connected controller 190 having its own graphic user interface 191, and driving multiple printing and scanning devices, such as the MFP device 162, a printing device 166, a scanning device 168, etc. As shown in FIG. 4, a single controller 190 can provide device selection services 192 for multiple devices 162, 166, 168. These devices can be connected to the controller 190 via wireless or wired connection 108. Since a workflow may require a user to interact with multiple devices, such devices can be located close to each other in some kind of local cluster. When using the controller 190 described herein, a user can select the device to which the controller 190 should connect.

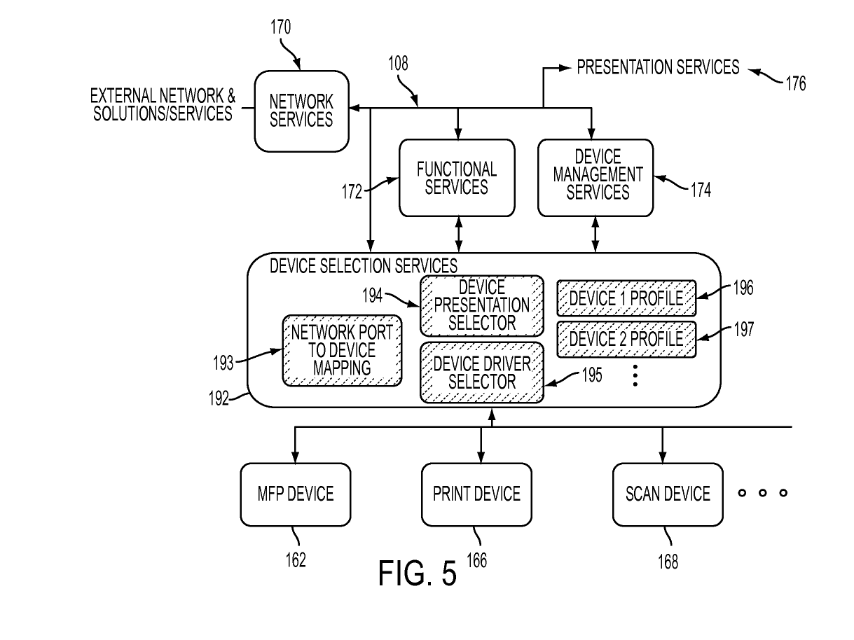

FIG. 5 shows the device selection services module 192 of systems and methods herein in greater detail. More specifically, the device selection services module 192 includes a network port to device mapping module 193, a device presentation selector 194, and a device driver selector 195. From such modules 193-195, the controller 190 is able to establish profiles of the devices 162, 166, 168 that are connected to the controller 190. For example, the device management services module 174 can maintain the capabilities, drivers, workflow information, connection information, etc., of each document processing device 162, 166, 168 to which the controller 190 has access.

Thus, when a device is selected by a user, the device management services module 174 will inform the presentation services module 176 of which workflows are available for a specific device. The device management services module 174 will also inform external services of the device capabilities and limitations to only allow the appropriate solution capabilities to be displayed through the presentation services 176. The controller 190 can also call up the correct driver for the device and establish a connection to the selected device. The device management services module 174 will also open up a network pathway for any interaction with the selected device.

When a workflow is selected and launched with the proper user input, the workflow process is conducted in the background, freeing the device management services module 174 to service a new request for device and workflow. A user can always use the device management services module 174 to display the status of a particular background workflow that is being executed. Notifications of status from the background workflows are displayed on the user interface in a notification area.

As described herein, a single controller 190 provides interactive web service interfaces for multiple devices that reduce the cost for installations to allow multiple devices to share capabilities, and allows low end devices that otherwise cannot afford such functionality to share in multi-device user interfaces. Also, the systems and methods herein provide an architecture where devices from many different manufacturers can share and be shared in workflows through a common interface, which increases the speed at which office solutions can be extended to an entire market and extends the capabilities of managed print services across many devices.

Thus, as described above with respect to FIGS. 3-5, an exemplary centralized connection entity 190 herein comprises external ports operatively connected to an internal processor 192 and to external document processing devices 162, 166, and 168. The document processing devices 162, 166, and 168 each have their own graphic user interface 164. The exemplary centralized connection entity 190 also includes modules of instructions 193-195.

Such modules include a mapping module 193 that maps the external ports to corresponding document processing devices, a device driver selector module 195 acquiring and storing drivers corresponding to each of the document processing devices, and a device presentation selector module 194 that provides device selection services to the graphic user interfaces 164 of the document processing devices 162, 166, and 168.

The processor 190 establishes dynamic profiles for each of the document processing devices 162, 166, and 168. Each of such dynamic profiles comprises (for each of the document processing devices 162, 166, and 168) current device connection specifications based on the mapping, and current device drivers based on the stored drivers. The device selection services displayed on the graphic user interfaces 164 of each of the document processing devices 162, 166, and 168 by the device presentation selector module 194 comprise currently available workflows processed using a corresponding device (a device being operated by a user selecting one of the device service selections from a graphic user interface) and other devices of the document processing devices 162, 166, and 168, as well as currently available management functions of the corresponding device and the other devices of the document processing devices 162, 166, and 168.

The currently available workflows and the currently available management functions are based on the dynamic profiles of each of the document processing devices 162, 166, and 168, and the currently available workflows and the currently available management functions change as the dynamic profiles of each of the document processing devices change. The currently available workflows can include, for example, scan services, fax services, copy services, print services, document processing services, and document finishing services. The currently available management functions can include, for example, accounting services, management services, presentation services, and authentication services.

Thus, a single selection of just one of the device service selections presented on the graphic user interface 164 of a corresponding device can select a currently available workflow that utilizes functionality of one or many of the other document processing devices 162, 166, and 168. Each individual device may lack sufficient computerized resources to be capable of independently establishing such dynamic profiles and providing the device selection services that this centralized connection device can.

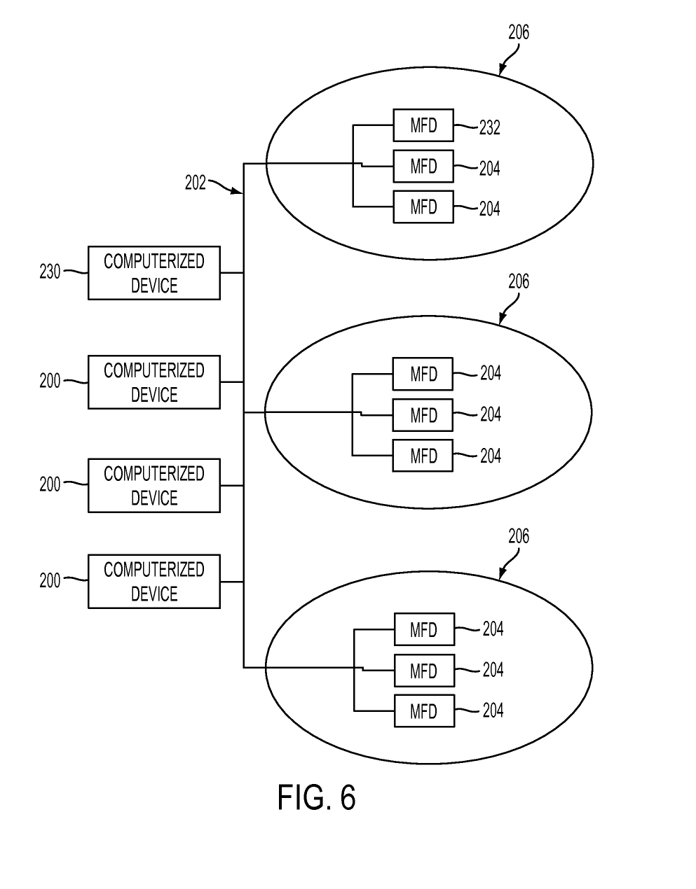

As shown in FIG. 6, exemplary systems and methods herein include various computerized devices 200, 204, 230, 232 located at various different physical locations 206. The computerized devices 200, 204, 230, 232 can include print servers, printing devices, personal computers, etc., and are in communication (operatively connected to one another) by way of a local or wide area (wired or wireless) network 202.

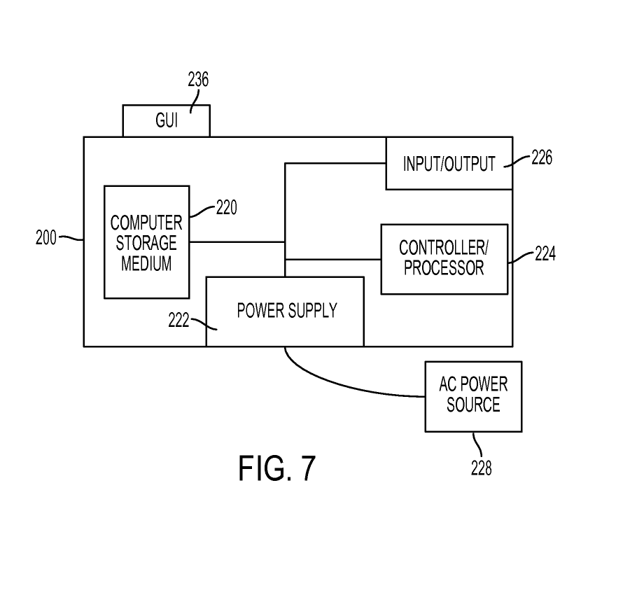

FIG. 7 illustrates a computerized device 200, 230 which can be used with systems and methods herein and can comprise, for example, a centralized controller, a print server, a personal computer, a portable computing device, etc. The computerized device 200, 230 includes a controller/processor 224 and a communications port (input/output) 226 operatively connected to the processor 224 and to the computerized network 202 external to the computerized device 200, 230. Also, the computerized device 200, 230 can include at least one accessory functional component, such as a graphic user interface assembly 236 that also operate on the power supplied from the external power source 228 (through the power supply 222).

The input/output device 226 is used for communications to and from the computerized device 200, 230. The processor 224 controls the various actions of the computerized device. A non-transitory computer storage medium device 220 (which can be optical, magnetic, capacitor based, etc.) is readable by the processor 224 and stores instructions that the processor 224 executes to allow the computerized device to perform its various functions, such as those described herein. Thus, as shown in FIG. 6, a body housing has one or more functional components that operate on power supplied from an alternating current (AC) source 228 by the power supply 222. The power supply 222 can comprise a power storage element (e.g., a battery, etc).

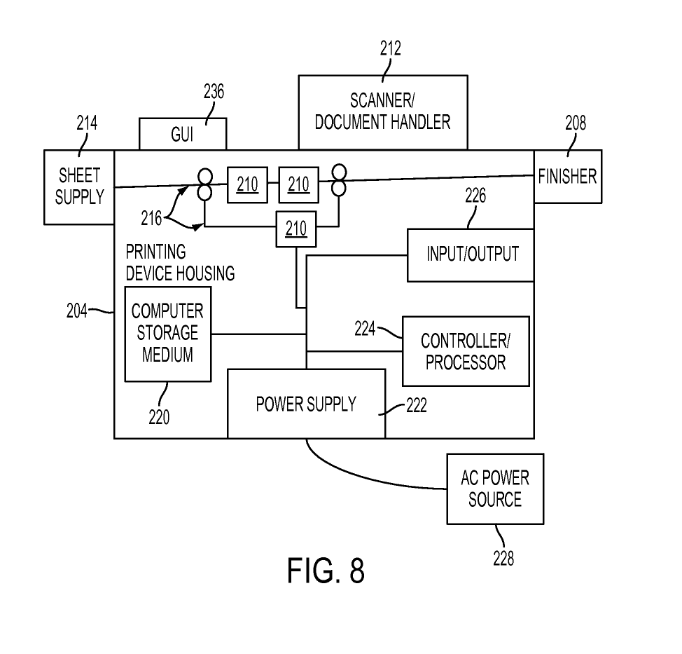

FIG. 8 illustrates a computerized device that is a document processing device 204, 232, which can be used with systems and methods herein and can comprise, for example, a printer, copier, multi-function machine, multi-function device (MFD), etc. The document processing device 204, 232 can includes many of the components mentioned above and at least one marking device (printing engines) 210 operatively connected to the processor 224, a media path 216 positioned to supply sheets of media from a sheet supply 214 to the marking device(s) 210, etc. After receiving various markings from the printing engine(s), the sheets of media can optionally pass to a finisher 208 which can fold, staple, sort, etc., the various printed sheets. Also, the document processing device 204, 232 can include at least one accessory functional component (such as a scanner/document handler 212, etc.) that also operate on the power supplied from the external power source 228 (through the power supply 222).

Therefore, as shown in FIGS. 6-8, various centralized connection devices 230 herein include one or more processors 224, external ports 226 operatively connected to the processor 224 and to document processing devices 204, 232, and one or more non-transitory computer-readable memory devices 220 operatively connected to the processor 224. The document processing devices 204, 232 each have some form of graphic user interface 236.

The processor 224 maps the external ports 226 to the document processing devices 204, 232 to establish and store (in the non-transitory computer-readable memory 220) current device connection specifications. The processor 224 also acquires drivers corresponding to each of the document processing devices 204, 232 to establish and store (in the non-transitory computer-readable memory 220) current device drivers. The processor 224 further determines current capabilities of each of the document processing devices 204, 232 to establish and store (in the non-transitory computer-readable memory 220) current device capabilities. The processor 224 additionally determines current workflow functions of each of the document processing devices 204, 232 to establish and store (in the non-transitory computer-readable memory 220) current device workflow functions.

The processor 224 then establishes dynamic profiles for each of the document processing devices 204, 232, based on the current device connection specifications, the current device drivers, the current device capabilities, and the current device workflow functions. The processor 224 of the centralized connection device can then provide device menu options to graphic user interfaces 236 of the document processing devices 204, 232.

The device menu options provided from the processor 224 of the centralized connection device cause the graphic user interfaces 236 of the document processing devices 204, 232 to display currently available workflows (that will be processed using a corresponding device 232 and at least one other device 204 of the document processing devices 204, 232) and currently available management functions for the corresponding device 232 and the other device(s) 204 of the document processing devices 204, 232. The “corresponding” device 232 again corresponds to the specific one of the graphic user interfaces 236 receiving input to the device menu options.

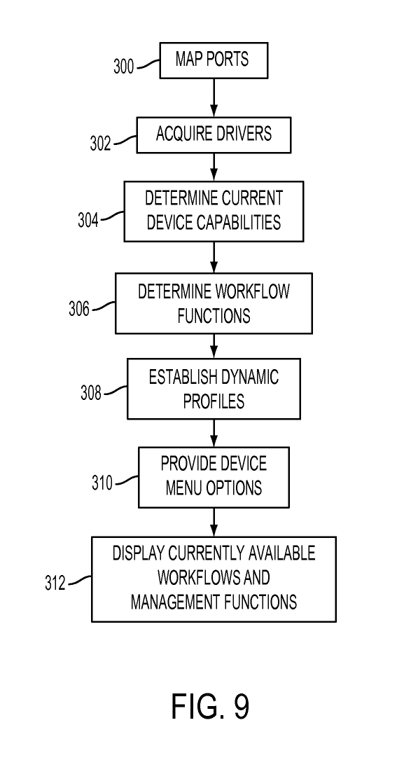

FIG. 9 is flowchart illustrating exemplary methods herein. Each of the processes shown in FIG. 9 is performed automatically (or is performed automatically in response to user input). In item 300, these methods map external ports of the centralized connection device to document processing devices to establish and store (in the non-transitory computer-readable memory of the centralized connection device) current device connection specifications, using a processor of the centralized connection device. Further, in item 302 such methods acquire drivers corresponding to each of the document processing devices to establish and store (in the non-transitory computer-readable memory of the centralized connection device) current device drivers, using the processor.

Additionally, in item 304 such methods determine the current capabilities of each of the document processing devices to establish and store (in the non-transitory computer-readable memory of the centralized connection device) current device capabilities, using the processor. These methods determine the current workflow functions of each of the document processing devices in item 306 to establish and store (in the non-transitory computer-readable memory of the centralized connection device) current device workflow functions, using the processor.

Then, such methods can establish dynamic profiles for each of the document processing devices in item 308, based on the current device connection specifications, the current device drivers, the current device capabilities, and the current device workflow functions, using the processor. These methods then provide device menu options to graphic user interfaces of the document processing devices, using the processor in item 310.

The device menu options provided from the processor of the centralized connection device cause the graphic user interfaces of the document processing devices to display currently available workflows (that will be processed using a corresponding device and at least one other device of the document processing devices) and currently available management functions for the corresponding device and the other device(s) of the document processing devices, as shown in item 312. The “corresponding” device again corresponds to the specific one of the graphic user interfaces receiving input to the device menu options.

Therefore, the systems and methods herein utilize a single sophisticated controller in conjunction with multiple low-end document processing devices (that may have processing capabilities that are substantially reduced when compared to the centralized controller). In this way, each individual low-end document processing device can be made less expensively because each is not required to have the more complex computing capabilities of the centralized controller. Instead, the cost of such sophisticated computing capabilities is shifted to the centralized controller, which makes the entire system more efficient overall.

Thus, because each individual document processing device only needs basic network communication abilities and display/user input capabilities (and does not need the sophisticated multi-device workflow calculation capabilities maintained by the centralized controller) each individual document processing device can be made in a less expensive manner. By making the individual document processing devices with less computing resources, each individual document processing device requires a lower material content (saving the Earth's resources) and also will be less complicated, thereby having higher yield and lower cost.

Further, the cost and material resource requirements of the centralized controller can be spread out over many units, thereby making the system (as a whole) less burdensome from an environmental and cost standpoint compared to conventional systems that require each individual document processing device to have substantial computing capabilities. These efficiencies are increased further as the number of devices that are connectable to the centralized controller increases and, therefore, these systems naturally lend themselves to wide area network conductivity and other similar uses.

Additionally, the centralized controller can be made very sophisticated and can constantly and dynamically track each different document processing device's current status, current drivers, and current capabilities, as well as each user's rights and access permissions/restrictions. Therefore, the workflow options and menus presented on the graphic user interfaces of the document processing devices by the centralized controller will change dynamically depending upon the functionality and availability of other document processing devices, and upon the user's current rights and restrictions.

Also, rather than simply providing menu emulation of a different device, the centralized controller can provide “single user input” menu options that, when operated by a single user input, cause an entire workflow (that potentially utilizes many different document processing devices) to be fully and automatically executed without any additional input from the user (after the single user input). Therefore, the centralized controller provides menu options that are not available on any specific document processing device menu, but instead are new menus created only for use by the centralized controller, and are created with the intent of using multiple different document processing devices.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes. Further, the terms automated or automatically mean that once a process is started (by a machine or a user), one or more machines perform the process without further input from any user.

It is appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A centralized connection entity comprising:
a processor;
external ports operatively connected to said processor and to document processing devices, said document processing devices having graphic user interfaces; and
a non-transitory computer-readable storage medium storing modules of instructions, said non-transitory computer-readable storage being operatively connected to said processor, said modules of instructions comprising:
a mapping module mapping ones of said external ports to corresponding ones of said document processing devices;
a device driver selector module acquiring and storing drivers corresponding to each of said document processing devices; and
a device presentation selector module providing device selection services to said graphic user interfaces of said document processing devices;
said processor establishing dynamic profiles for each of said document processing devices,
each of said dynamic profiles comprising, for each of said document processing devices, current device connection specifications based on said mapping, and current device drivers based on said acquiring and storing drivers,
said device selection services displayed on said graphic user interfaces of each of said document processing devices by said device presentation selector module comprising currently available workflows processed using a corresponding device and other devices of said document processing devices, and currently available management functions of said corresponding device and said other devices of said document processing devices, and
said currently available workflows comprising different menus that are not available on menus of any single one of said document processing devices, and said different menus are only for processing by said processor of said centralized connection entity.

2. The centralized connection entity according to claim 1, said currently available workflows and said currently available management functions being based on said dynamic profiles of each of said document processing devices, and
said currently available workflows and said currently available management functions changing as said dynamic profiles of each of said document processing devices changes.

3. The centralized connection entity according to claim 1, selection of said currently available workflows utilizing functionality of at least two of said document processing devices through a single selection of one of said device selection services presented on a graphic user interface of said corresponding device.

4. The centralized connection entity according to claim 1, said currently available workflows comprising scan services, fax services, copy services, print services, document processing services, and document finishing services.

5. The centralized connection entity according to claim 1, said currently available management functions comprising accounting services, management services, presentation services, and authentication services.

6. The centralized connection entity according to claim 1, said corresponding device comprising a device being operated by a user selecting one of said device selection services from a graphic user interface of said corresponding device.

7. The centralized connection entity according to claim 1, said corresponding device lacking computerized resources capable of independently establishing said dynamic profiles and providing said device selection services.

8. A centralized connection device comprising:
a processor;
external ports operatively connected to said processor and to document processing devices, said document processing devices having graphic user interfaces; and
a non-transitory computer-readable memory operatively connected to said processor,
said processor mapping said external ports to said document processing devices to establish and store, in said non-transitory computer-readable memory, current device connection specifications,
said processor acquiring drivers corresponding to each of said document processing devices to establish and store, in said non-transitory computer-readable memory, current device drivers,
said processor determining current capabilities of each of said document processing devices to establish and store, in said non-transitory computer-readable memory, current device capabilities,
said processor determining current workflow functions of each of said document processing devices to establish and store, in said non-transitory computer-readable memory, current device workflow functions,
said processor establishing dynamic profiles for each of said document processing devices, based on said current device connection specifications, said current device drivers, said current device capabilities, and said current device workflow functions,
said processor providing device menu options to graphic user interfaces of said document processing devices,
said device menu options provided from said processor of said centralized connection device causing said graphic user interfaces of said document processing devices to display:
currently available workflows processed using a corresponding device and at least one other device of said document processing devices, said corresponding device corresponding to a specific one of said graphic user interfaces receiving input to said device menu options; and
currently available management functions for said corresponding device and said at least one other device of said document processing devices, and
said currently available workflows comprising different menus that are not available on menus of any single one of said document processing devices, and said different menus are only for processing by said processor of said centralized connection device.

9. The centralized connection device according to claim 8, said currently available workflows and said currently available management functions being based on said dynamic profiles of each of said document processing devices, and
said currently available workflows and said currently available management functions changing as said dynamic profiles of each of said document processing devices changes.

10. The centralized connection device according to claim 8, selection of said currently available workflows utilizing functionality of at least two of said document processing devices through a single selection of one of said device menu options presented on a graphic user interface of said corresponding device.

11. The centralized connection device according to claim 8, said currently available workflows comprising scan services, fax services, copy services, print services, document processing services, and document finishing services.

12. The centralized connection device according to claim 8, said currently available management functions comprising accounting services, management services, presentation services, and authentication services.

13. The centralized connection device according to claim 8, said corresponding device lacking computerized resources capable of independently establishing said dynamic profiles and providing said device menu options.

14. The centralized connection device according to claim 8, said centralized connection device being connected to said document processing devices through one of a wired network and a wireless network.

15. A method comprising:
mapping external ports of a centralized connection device to document processing devices to establish and store, in a non-transitory computer-readable memory of said centralized connection device, current device connection specifications, using a processor of said centralized connection device;
acquiring drivers corresponding to each of said document processing devices to establish and store, in said non-transitory computer-readable memory, current device drivers, using said processor;
determining current capabilities of each of said document processing devices to establish and store, in said non-transitory computer-readable memory, current device capabilities, using said processor;
determining current workflow functions of each of said document processing devices to establish and store, in said non-transitory computer-readable memory, current device workflow functions, using said processor;
establishing dynamic profiles for each of said document processing devices, based on said current device connection specifications, said current device drivers, said current device capabilities, and said current device workflow functions, using said processor; and
providing device menu options to graphic user interfaces of said document processing devices, using said processor,
said device menu options provided from said processor of said centralized connection device causing said graphic user interfaces of said document processing devices to display:
currently available workflows processed using a corresponding device and at least one other device of said document processing devices, said corresponding device corresponding to a specific one of said graphic user interfaces receiving input to said device menu options; and
currently available management functions for said corresponding device and said at least one other device of said document processing devices, and
said currently available workflows comprising different menus that are not available on menus of any single one of said document processing devices, and said different menus are only for processing by said processor of said centralized connection device.

16. The method according to claim 15, said currently available workflows and said currently available management functions being based on said dynamic profiles of each of said document processing devices, and
said currently available workflows and said currently available management functions changing as said dynamic profiles of each of said document processing devices changes.

17. The method according to claim 15, selection of said currently available workflows utilizing functionality of at least two of said document processing devices through a single selection of one of said device menu options presented on a graphic user interface of said corresponding device.

18. The method according to claim 15, said currently available workflows comprising scan services, fax services, copy services, print services, document processing services, and document finishing services.

19. The method according to claim 15, said currently available management functions comprising accounting services, management services, presentation services, and authentication services.

20. The method according to claim 15, said corresponding device lacking computerized resources capable of independently establishing said dynamic profiles and providing said device menu options.
